(19) United States
(12) Patent Application Publication
(10) Pub. No.: US 2025/0371826 A1
(43) Pub. Date: Dec. 4, 2025

(54) VOLUMETRIC NEURAL STYLE TRANSFER MASKING

(71) Applicant: Pixar, Emeryville, CA (US)

(72) Inventor: Jonathan V. HOFFMAN, Oakland, CA (US)

(21) Appl. No.: 18/676,366

(22) Filed: May 28, 2024

(51) Int. Cl. G06T 19/20; G06T 15/08

(52) U.S. Cl. CPC G06T 19/20; G06T 15/08; G06T 2219/2016; G06T 2219/2024

(57) ABSTRACT

Embodiments provide for volumetric neural style transfer are provided. A plurality of voxels corresponding to a three-dimensional virtual volume in a virtual space is accessed. The plurality of voxels is processed using a volumetric neural style transfer (VNST) machine learning model to generate a vector field comprising, for each respective voxel of the plurality of voxels, a respective displacement vector. A direction of motion of the three-dimensional virtual volume in the virtual space is determined, and the vector field is masked based at least in part on the direction of motion. The plurality of voxels is modified based on the masked vector field.

### BACKGROUND

A wide variety of machine learning models have been developed to assist or facilitate the process of generating and modifying visual information. Some models have been trained to transfer the artistic style from one input (e.g., an image) to the content of another (e.g., another image). For example, neural style transfer (NST) may use deep neural network models to modify the content of one image (e.g., a photograph) based on the style of another (e.g., a painting), such that the output generally depicts the content of the first image (e.g., the content of the photograph) in the style of the second (e.g., appearing as a painting).

Volumetric neural style transfer can similarly be used to replicate particular styles onto and/or into a volume (e.g., a three-dimensional volume defined by a set of voxels). However, some existing techniques are overly aggressive in the transfer, and often apply the stylization in undesired ways. For example, existing techniques often result in awkward visual artifacts (e.g., random holes appearing in the volume)

### SUMMARY

In some embodiments of the present disclosure, a method is provided. The method includes accessing a plurality of voxels corresponding to a three-dimensional virtual volume in a virtual space; processing the plurality of voxels using a volumetric neural style transfer (VNST) machine learning model to generate a vector field comprising, for each respective voxel of the plurality of voxels, a respective displacement vector; determining a direction of motion of the three-dimensional virtual volume in the virtual space; masking the vector field based at least in part on the direction of motion; and modifying the plurality of voxels based on the masked vector field.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; and a computer program product embodied on a computer-readable storage medium comprising code for performing the aforementioned methods as well as those further described herein.

The following description and the related drawings set forth in detail certain illustrative features of one or more embodiments.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example workflow for improved volumetric neural style transfer using masking, according to some embodiments of the present disclosure.

FIG. 2 depicts an example location-based masked volumetric neural style transfer on voxel data, according to some embodiments of the present disclosure.

FIG. 3 depicts an example age-based masked volumetric neural style transfer on voxel data, according to some embodiments of the present disclosure.

FIG. 4 is a flow diagram depicting an example method for masked volumetric neural style transfer on voxel data, according to some embodiments of the present disclosure.

FIG. 5 is a flow diagram depicting an example method for masking vector fields to improve volumetric neural style transfer on voxel data, according to some embodiments of the present disclosure.

FIG. 6 is a flow diagram depicting an example method for volumetric neural style transfer, according to some embodiments of the present disclosure.

FIG. 7 depicts an example computing device configured to perform various aspects of the present disclosure.

### DETAILED DESCRIPTION

Embodiments of the present disclosure provide improved mask-based volumetric neural style transfer (VNST). Embodiments of the present disclosure can generally be used to efficiently modify or control the VNST process, resulting in improved output (e.g., output volumes that more closely align with desired visuals) without introducing significant computational overhead.

In some embodiments of the present disclosure, dynamic style transfer masking is used to modify the way style is transferred to the volume, significantly improving control over the resulting visuals while maintaining efficient transfer without additional training overhead. In some embodiments of the present disclosure, a “volume” generally refers to a multidimensional region of virtual space (e.g., a volumetric entity). In some aspects, the volume may comprise and/or be represented by a set of voxels (also referred to as volumetric pixels in some aspects), where each voxel may generally have characteristics such as a location and/or orientation in the virtual space, opacity, color, motion, and the like. In some aspects, voxel-based volumes can be used to effectively generate fluid-based entities, such as clouds, fog, smoke, fire, water, and the like.

In some aspects, animation techniques such as physics-based simulations can be used to generate desired effects or volumes in virtual space (e.g., smoke billowing up, flames covering an object, and the like). However, such simulations are fairly constrained in the adaptability and customization options available. Moreover, simulations can often be computationally expensive to perform, making iterative adjustment time consuming and burdensome. In some embodiments, VNST can be used to apply stylistic modifications to the simulated volume. For example, images (e.g., grayscale or black and white) depicting the desired style (e.g., spirals, straight lines, or other stylistic elements) can be used to train a VNST machine learning model. The model can then be used to transfer the style depicted in the image(s) to the simulated volume (e.g., making billowing smoke exhibit more spiraling or twisting).

In some embodiments, the VNST machine learning model processes a set of input voxels (e.g., the voxels representing the volumetric entity at a particular point in time, such as for a given animation frame) to generate a vector field. The vector field may generally include a set of displacement vectors (e.g., one for each voxel) indicating how the corresponding voxel should be moved, displaced, or otherwise transformed to impart the style learned during training of the model. For example, each displacement vector may be a vector in three-dimensional space originating at the current location of the voxel (in the input data) and terminating at the target or end location to which the voxel should be moved. Applying the vector field to the voxels (e.g., by moving each voxel according to the corresponding displacement vector) transfers the desired style to the volume.

However, as discussed above, this straight style transfer can result in substantial visual artifacts and concerns due to the complex volumetric nature of the volume. In some aspects, therefore, transfer masking is used to control the particular style transfer based on characteristics such as each voxel's current location in the space, the movement of each voxel, the age of each voxel, and the like. For example, the vector field may be masked (which may include application of a binary mask and/or application of a non-binary mask to scale the displacement vectors) based on various criteria or rules used to control the visual style of the output. This masked vector field can then be used to modify the voxel inputs. Advantageously, this masking can be implemented using a multiplication operation with minimal computational expense and latency, allowing for rapid iteration and experimentation with various stylistic choices (e.g., modifying the masking and generating a new modified set of voxels to visualize the changes).

In these ways, embodiments of the present disclosure can substantially improve the three-dimensional modeling and animation process, allowing for more fine-grained control and more accurate and appealing visual outputs without introducing substantial computational expense or latency in the generation or rendering process.

### Example Workflow for Improved Volumetric Neural Style Transfer Using Masking

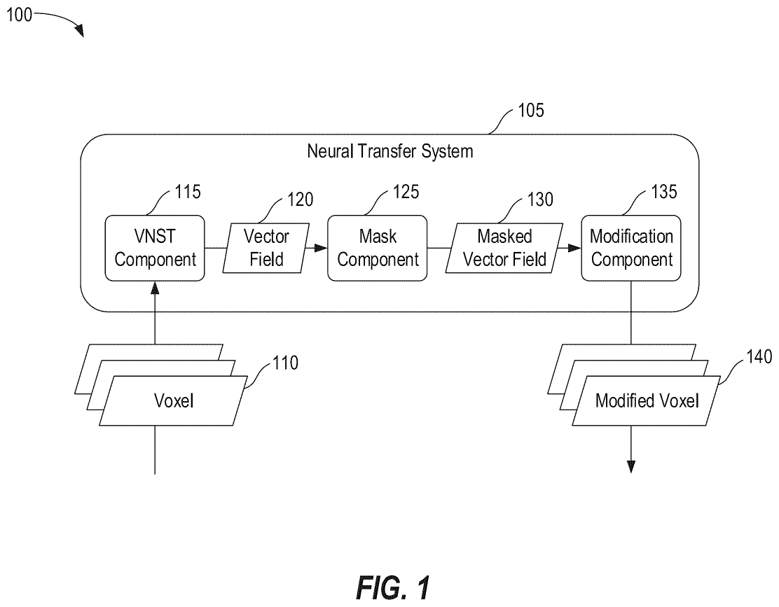

FIG. 1 depicts an example workflow 100 for improved volumetric neural style transfer using masking, according to some embodiments of the present disclosure.

In the illustrated example, an input set of voxels 110 (e.g., representing a volumetric entity, such as a plume of smoke or fire) is accessed by a neural transfer system 105. As used herein, “accessing” data may generally include receiving, requesting, retrieving, obtaining, generating, collecting, or otherwise gaining access to the data. For example, the neural transfer system 105 may generate the initial voxels 110 (e.g., using a physics-based smoke or flame simulator), or may receive the voxels 110 from another computing system and/or a user. Although depicted as a physical entity for conceptual clarity, in some aspects, the neural transfer system 105 may be implemented using hardware, software, or a combination of hardware and software, and the operations of the neural transfer system 105 may be combined or distributed across any number of systems.

As discussed above, the voxels 110 each generally correspond to a defined unit or region of space (e.g., a three-dimensional virtual space in a modeling or animation environment). In some aspects, each voxel 110 is a discrete element or portion of the space (e.g., arranged in a grid structure). For example, if the virtual environment includes a fire element, the voxels 110 may encompass the space occupied by the fire, where each voxel makes up a relatively small part of the fire element. Generally, the particular size of the voxels 110 may vary depending on the particular implementation. Although not included in the illustrated example, each voxel 110 may have various characteristics such as opacity values, texture values, location and/or orientation values, and the like.

In some aspects, the voxels 110 correspond to a single frame of an animation. That is, the volumetric entity may be an animated model (e.g., a sequence of frames, where the voxels 110 may transform, move, or otherwise be modified across frames). For example, voxels may be generated or spawned at a base or initial point of the fire element, and may then be transformed across frames (e.g., rising up, changing size, shape, color, and/or opacity, and then being deleted at the top of the flame element). The set of voxels 110 depicted in the workflow 100 may therefore correspond to the state of the volumetric entity at one point in time. In some aspects, as discussed above, the characteristics of the voxels 110 may be generated using physics-based simulation of fluid mechanics (e.g., for smoke, fire, water, fog, clouds, and the like).

In the illustrated workflow 100, the neural transfer system 105 includes a VNST component 115, a mask component 125, and a modification component 135. Though illustrated as discrete components for conceptual clarity, the operations of the depicted components (and others not illustrated) may be combined or distributed across any number of components or systems, and may generally be implemented using hardware, software, or a combination of hardware and software.

As illustrated, the voxels 110 are accessed by a VNST component 115 to generate a vector field 120. In some aspects, the VNST component 115 uses a trained VNST machine learning model to generate the vector field 120. In some embodiments, as discussed above, the VNST model generally corresponds to a machine learning model (e.g., a deep neural network) trained to transfer style reflected in one or more training inputs (e.g., images) to a volumetric object (e.g., a set of voxels). For example, as discussed above, the training input may include one or more image(s) depicting desired stylistic characteristics such as swirls, spirals, twists, or other visual attributes.

In some embodiments, the vector field 120 comprises a set of displacement vectors (e.g., one vector for each voxel 110). Each displacement vector generally indicates a change in location of the corresponding voxel 110 that, if applied, will cause the volumetric entity (e.g., the group of voxels) to exhibit the style learned by the VNST model. For example, the simulated fire or smoke may exhibit more spiraling, twisting, or other features depicted in the training image(s).

In some embodiments, applying the vector field 120 directly to the voxels 110 can result in sub-optimal or undesirable artifacts and visual glitches. That is, transferring the desired style directly to all voxels 110 (using the vector field 120) often does not achieve the desired results. For example, while the resulting output may generally mirror the desired style, desired aspects of the original volume may also be lost, and the transferred style may impair or reduce the overall quality of the model.

In the illustrated example, the vector field 120 is accessed by a mask component 125 to generate a masked vector field 130. The mask component 125 may generally use a variety of criteria, rules, or other techniques to dynamically modify the vector field 120 and allow fine-grained control of the output. For example, in some aspects, the mask component 125 may mask the vector field 120 based on the position or location of the corresponding voxels 110. Generally, such position-based masking may include evaluation of the absolute position of each voxel in the three-dimensional space and/or the position of each voxel relative to the volumetric entity itself (e.g., on the interior of the volume, on the exterior of the volume, and the like). For example, the mask component 125 may mask or modify displacement vectors corresponding to voxels on the exterior surface of the volume differently, as compared to vectors corresponding to voxels in the interior of the volume.

In some aspects, the position-based masking may include evaluation of the position of the voxels with respect to motion of the volume or underlying object. For example, if the volume (e.g., a fire effect) is on or part of a character or other object (e.g., a burning fire-based character), the mask component 125 may determine the movement of the volume (e.g., following the character's movement), and may mask the vector field 120 based on this movement (e.g., to reduce or eliminate style transfer for voxels on the leading edge or side of the movement).

As another example, in some aspects, the mask component 125 may evaluate other characteristics of the voxels 110 and/or vector field 120, such as the voxel ages. For example, the mask component 125 may mask the vector field 120 based in part on the age of the corresponding voxel (e.g., the number of frames or amount of time that has elapsed, in the simulation or animation, since the voxel was spawned or created). For example, the mask component 125 may mask the displacement vector more (or entirely) for newly-created voxels, are compared to older voxels (e.g., allowing more style transfer for older voxels).

Generally, the mask component 125 may evaluate a wide variety of criteria to mask style transfer, depending on the particular implementation. In some aspects, the mask component 125 uses a binary masking operation. That is, the mask component 125 may, for one or more displacement vector in the vector field 120, either leave the vector unchanged (e.g., allowing full style transfer for the corresponding voxel), or set the vector to a value of zero (e.g., eliminating style transfer for the corresponding voxel). In some embodiments, the mask component 125 may additionally or alternatively use a non-binary masking operation. That is, the mask component 125 may, for each displacement vector in the vector field 120, scale the vector by a determined amount (e.g., between zero, indicating no style transfer, and one, indicating full style transfer) based on the various masking criteria. For example, the mask component 125 may set the displacement vector to a value of zero for some voxels (eliminating style transfer) and gradually increase the mask scale across a sequence of voxels (e.g., across time and/or space) until fully style transfer is applied to another set of voxels (or the same set of voxels at a different time in the animation, such as a different frame).

In the illustrated workflow 100, the masked vector field 130 is generated by combining the vector mask (e.g., a binary or non-binary mask) with the vector field 120 (e.g., by elementwise multiplying the mask with the vector field 120, such at each displacement vector in the vector field 120 is multiplied with a corresponding scale value in the mask). The masked vector field 130 is then accessed by a modification component 135 to generate a set of modified voxels 140.

In some aspects, as discussed above, the modification component 135 may generate the set of modified voxels 140 by applying the masked vector field 130 to the voxels 110. For example, the modification component 135 may, for each voxel 110, identify the corresponding (masked) displacement vector in the masked vector field 130, and move or displace the voxel 110 along the displacement vector (e.g., placing each voxel in a new location in the three-dimensional space). As discussed above, using the masked vector field 130, the modification component 135 can therefore generate an output volume (e.g., the modified voxels 140) that reflects the desired style in a more controlled manner (e.g., reducing or eliminating style transfer for some voxels while preserving it for others).

Although not illustrated in the example workflow 100, this style transfer process may be performed for each frame (e.g., each set of voxels) of an animation, allowing the style transfer to be applied to an animated volume in virtual space. In some aspects, the neural transfer system 105 (or another system) may then render an image of the modified voxels 140 (e.g., based on a defined camera object in the scene) to create an output image depicting the modified volumetric element.

### Example Location-Based Masked Volumetric Neural Style Transfer on Voxel Data

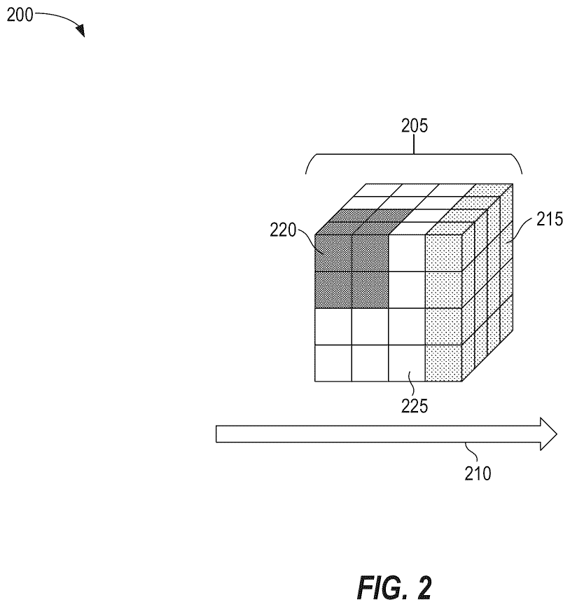

FIG. 2 depicts example location-based masked volumetric neural style transfer on voxel data, according to some embodiments of the present disclosure. In some aspects, the depicted example is used by a neural transfer system, such as the neural transfer system 105 of FIG. 1.

In the illustrated example, a three-dimensional virtual volume 205 comprising a set of voxels (e.g., the voxels 110 of FIG. 1) is depicted. In the illustrated example, the volume 205 is a cube, and each voxel is depicted as a smaller cube forming the volume. That is, in the illustrated example, the volume 205 comprises sixty-four cubic voxels arranged in a cube (e.g., four voxels wide, four voxels tall, and four voxels deep). Alternatively, the volume 205 may be hollow (e.g., with a total of fifty-six voxels forming the outside surfaces, and a hollow space in the middle). Although the illustrated example depicts a cubic volume 205, the volume may generally form any three-dimensional shape. Further, although the illustrated voxels are themselves cubes, the voxels may have any three-dimensional shape depending on the particular implementation. Additionally, although the illustrated example depicts the voxels arranged in a uniform grid, in some embodiments, the voxels may be distributed uniformly or non-uniformly.

In the illustrated example, the volume 205 is moving from the left to the right (as illustrated by the arrow 210). That is, the volume 205 may be part of a three-dimensional animation, where during the animation, the volume 205 (or an object to which the volume is attached or associated) moves along the arrow 210. In some aspects, as discussed above, the neural transfer system may perform style transfer masking based at least in part on the positions or locations of the voxels (including their position within the volume 205, their position relative to the virtual space itself, and/or their position relative to the movement of the volume 205).

Specifically, as illustrated, a first set of voxels 215 may be masked based on their position on the leading edge of the volume 205. That is, the neural transfer system may determine the direction of the motion of the character or other three-dimensional model associated with the volume 205 (e.g., if the character is moving from left to right, and the volume 205 corresponds to a fire effect attached to or otherwise associated with the character) and identify the voxel(s) on the leading surface or side of the volume 205 (e.g., the voxels facing towards the movement of the model). For example, in some aspects, the neural transfer system may project parallel rays in the opposite direction of the motion, selecting voxels that are struck by the rays (and terminating each ray when it strikes a voxel) to identify the voxels on the leading edge of the volume 205. In some embodiments, the system may perform a frame-by-frame comparison of points on the animated geometry in order to identify the directionality of the motion. Although the illustrated example depicts a set of voxels 215 on the leading edge of the motion, the neural transfer system may similarly identify voxels in other positions relative to the motion, such as on the trailing surface (e.g., to eliminate or enhance style transfer for these voxels).

In some aspects, as discussed above, the neural transfer system may scale the displacement vectors of voxels in the set of voxels 215 (on the leading edge of the volume 205) by a smaller amount (e.g., a smaller masked displacement vector) as compared to displacement vectors for other voxels not on the leading edge. For example, the neural transfer system may scale the displacement vectors corresponding to the voxels in the set of voxels 215 to zero (or another relatively low number), reducing or eliminating style transfer to these voxels while retraining more stylization of voxels that are not on the leading surface. This may include, for example, refraining from masking the non-leading voxels, or scaling the stylization (e.g., the displacement vector) of each voxel based in part on its distance from the leading surface (e.g., such that each voxel receives style scaling proportional to the voxel's distance to the nearest leading surface).

In some aspects, such motion-based masking can enhance the visual effect of the motion of the volume 205 (e.g., causing a fire or smoke effect to appear to billow more dramatically or stylistically in the trailing wake of the moving volume 205, and simulating the effect of wind to blow away or reduce stylization of the fire or smoke on the leading surfaces). Although the illustrated example depicts a cube moving, in aspects, similar motion-based masking may be applied to any volume (including to sub-parts of a volume). For example, in some aspects, motion-based masking may be applied to the movement of a character's arms, legs, head, body, and the like (with masking performed based on how each part of the character is moving).

As another example, as illustrated, a second set of voxels 220 may be masked based on their position relative to the volume 205. That is, the neural transfer system may identify a set of voxel(s) 220 that are located in a defined location or region of the volume 205 for masking. For example, in some aspects, a user (e.g., a character designer) may designate specific regions or areas (e.g., voxels in the region) as non-transfer voxels, indicating that style should not be transferred to these voxels. As one example, portions of a character such as their face, hands, feet, and the like may be designated as non-transfer to prevent (or reduce) the style from being transferred to these elements, thereby enhancing or preserving the original underlying appearance (e.g., to ensure the character's face and hands are clearly visible without stylization introduced by the VNST). Although the set of voxels 220 is referred to as a non-transfer region, in some aspects, the neural transfer system may similarly identify enhanced transfer or other modified transfer regions (e.g., voxels labeled to indicate that style transfer should be preserved, enhanced, or otherwise modified for the indicated voxels).

In some embodiments, a variety of methods or techniques may be used to identify or define voxels for transfer (or non-transfer) of style. For example, an artist or designer may paint portions or regions of the model (e.g., the character), and these regions may then be projected from the camera onto the volume (or otherwise transferred to the volume), identifying the relevant voxels for transfer (or non-transfer). As another example, points may be identified or designated as transfer or non-transfer in a relatively sparse three-dimensional voxel grid, and these points may be interpolated into the higher resolution final volume to indicate the desired style transfer.

In some aspects, as discussed above, the neural transfer system may scale the displacement vectors of voxels in the set of voxels 220 (e.g., non-transfer voxels of the volume 205) by a smaller amount (e.g., a smaller masked displacement vector) as compared to displacement vectors for other voxels not in these region(s). For example, the neural transfer system may scale the displacement vectors corresponding to the voxels in the set of voxels 220 to zero (or another relatively low number), reducing or eliminating style transfer to these voxels while retraining more stylization of voxels that are not in the indicated regions. This may include, for example, refraining from masking the other voxels, or scaling the stylization (e.g., the displacement vector) of each voxel based in part on its distance from the designated non-transfer voxels (e.g., such that each voxel receives style scaling proportional to the voxel's distance to the non-transfer region, allowing a gradient of stylization to be applied rather than a hard or binary cutoff).

In the illustrated example, the set of voxels 225 corresponds to voxels in the volume 205 that are not affected by the masking. For example, the neural transfer system may modify or scale the displacement vectors for voxels in the sets of voxels 215 and 220, while leaving the displacement vectors for the voxels in the set of voxels 225 unchanged in the vector field. That is, because the set of voxels 225 are neither on the leading surface of the volume 205 (relative to the motion) nor in designated non-transfer areas, the neural transfer system may determine to apply unmodified style transfer to these voxels. In some aspects, as discussed above, the neural transfer system may alternatively apply scaling to the displacement vectors of the set of voxels 225 as well (e.g., proportional to the distance between each voxel and the nearest leading edge and/or non-transfer region).

In some aspects, as discussed above, voxels may move over time (e.g., across frames) in an animation. In some aspects, therefore, the masking of such voxels may similarly change over time. For example, if the direction of motion changes, the set of voxels 215 may change. Similarly, if the voxels themselves move (e.g., moving upward in a fire or smoke volume 205), the non-transfer designation may be applied to voxels as they enter the indicated area (corresponding to the set of voxels 220 in the illustrated example) and removed from voxels as they leave the designated area.

Generally, the particular masking (e.g., scaling) used by the neural transfer system may vary depending on the particular implementation.

### Example Age-Based Masked Volumetric Neural Style Transfer on Voxel Data

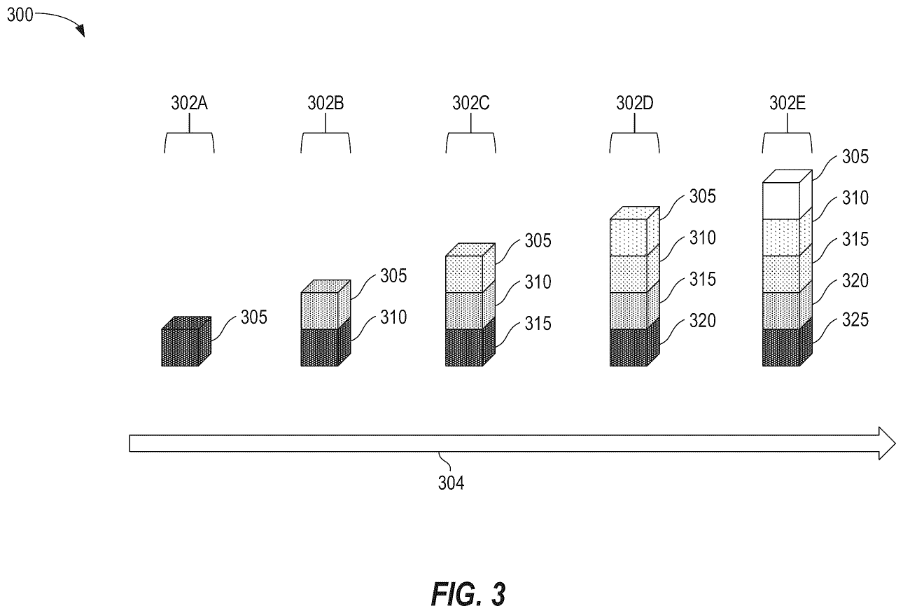

FIG. 3 depicts an example age-based masked volumetric neural style transfer on voxel data, according to some embodiments of the present disclosure. In some aspects, the depicted example is used by a neural transfer system, such as the neural transfer system 105 of FIG. 1 and/or the neural transfer system discussed above with reference to FIG. 2.

In the illustrated example, a three-dimensional virtual volume 302A-E (collectively, volume 302) comprising a set of voxels is depicted. In the illustrated example, each depicted volume 302A-E corresponds to the same volume at a different point in time (e.g., in a different frame), as indicated by the arrow 304 and discussed in more detail below. In the illustrated example, each voxel is depicted as a cube. Although the illustrated example depicts cubic voxels, the voxels may be represented using any three-dimensional shape depending on the particular implementation. Additionally, although the illustrated example depicts the voxels arranged in a uniform grid, in some embodiments, the voxels may be distributed uniformly or non-uniformly.

In the illustrated example, at a first time (e.g., for a first frame), the volume 302A includes a single voxel 305. At a second time (e.g., in a subsequent frame), the volume 302B includes the voxel 305 and a voxel 310. Further, as illustrated, the first voxel 305 has moved upwards, and the new voxel 310 has been spawned or created beneath the original voxel 305. As illustrated, in the volume 302C (e.g., at a subsequent time or frame), the voxels 305 and 310 have moved upwards and a new voxel 315 has been added to the volume 302C. Similarly, at a subsequent time, the volume 302D includes a new voxel 320 (with the voxels 305, 310, and 315 moved upwards), and at another subsequent time, the volume 302E includes a new voxel 325 (with the voxels 305, 310, 315, and 320 moved upwards).

That is, in the illustrated example, voxels are created at a first point in the volume 302, and are moved upwards across subsequent frames (e.g., rising upward as in a fire or smoke effect). Further, as depicted by the stippling of each voxel, the neural transfer system may mask the style transfer (e.g., scale the displacement vectors) proportionally to the movement and/or age of the voxels. For example, as illustrated, each voxel is initially depicted with heavy stippling (e.g., to indicate little or no style transfer). That is, the neural transfer system may initially the scale displacement vector of a given voxel to a low value (e.g., zero or near zero) when the voxel is newly created. Then, in subsequent frames, the neural transfer system may scale the displacement vector by a larger amount (as indicated by the decreasing stippling density) based on the age of the voxel (e.g., the time or number of frames that have elapsed since the given voxel was created). That is, the neural transfer system may scale the displacement vector by an amount that is proportional to the age of the voxel (where older voxels receive larger displacement vectors and, therefore, more stylization relative to newer voxels).

Specifically, as illustrated, during one frame (illustrated by the volume 302A), the voxel 305 receives little or no stylization (e.g., the displacement vector is scaled to a low or zero value). During a subsequent frame (illustrated by the volume 302B), the voxel 305 receives somewhat more stylization (e.g., the displacement vector is scaled to a somewhat higher value), as compared to the first frame. During each subsequent frame 302C-E, the stylization of the voxel 305 may be increased (as indicated by increasing density of the stippling) by scaling the displacement vector of the voxel 305 to larger amounts (e.g., closer to the original unscaled vector).

Although the illustrated example depicts the voxels moving over time, in some aspects, the masking may be applied based on the age of the voxels even in the absence of motion of the voxels themselves (e.g., where each voxel is created, progressively receives more and more stylization using higher displacement vector scaling over time, and is eventually deleted or removed).

In some aspects, the dynamic age-based masking of FIG. 3 may be combined with the dynamic position and/or motion-based masking discussed above with reference to FIG. 2. For example, the neural transfer system may, for each voxel in the volume, determine a scaling value (also referred to in some aspects as a scaling factor) based on a combination of characteristics including the motion of the volume and/or the voxel itself, the relative position of the voxel within the volume (e.g., whether it is within a designated non-transfer region), the age of the voxel, and the like. Further, as discussed above, the neural transfer system may use any number and variety of other masking rules or techniques to apply dynamic scaling to the volume stylization. As a result, as discussed above, users (e.g., designers) may exert substantial control over the impact of the neural style transfer, significantly improving the design process and further improving the visual quality of the generated models and animations.

### Example Method for Masked Volumetric Neural Style Transfer on Voxel Data

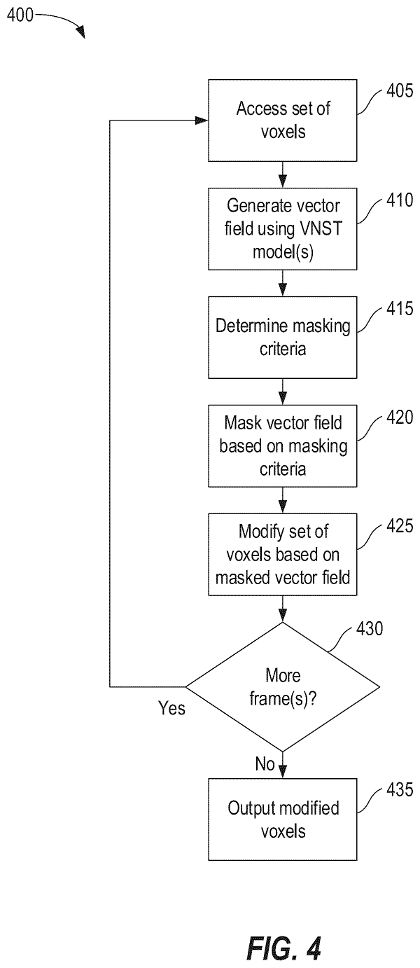

FIG. 4 is a flow diagram depicting an example method 400 for masked volumetric neural style transfer on voxel data, according to some embodiments of the present disclosure. In some aspects, the method 400 is performed by a neural transfer system, such as the neural transfer system 105 of FIG. 1 and/or the neural transfer systems discussed above with reference to FIGS. 2-3.

At block 405, the neural transfer system accesses a set of voxels (e.g., the voxels 110 of FIG. 1). In some aspects, as discussed above, the voxels may generally represent or correspond to a volumetric entity in a three-dimensional virtual scene (e.g., used for computer-assisted modeling and/or animation). In some aspects, as discussed above, the voxels may be part of an animation (e.g., where the set of voxels may change over time, such as by adding new voxels, removing voxels, changing the locations and/or orientations of the voxels, and/or changing other characteristics of the voxels). In some embodiments, the voxels are generated based at least in part on a simulation operation (e.g., a physics-based simulator used to simulate the motion or effect of a fluid such as a fire, smoke, cloud, water, and the like).

At block 410, the neural transfer system generates a vector field (e.g., the vector field 120 of FIG. 1) using one or more VNST machine learning models. For example, as discussed above, the neural transfer system may process the voxel(s) as input to the VNST model(s) to generate the vector field. In some embodiments, the VNST model(s) generally correspond to trained machine learning models (e.g., deep neural networks) trained to perform style transfer onto volumetric elements (e.g., voxels) based on training data (e.g., images depicting the desired style). In some embodiments, the vector field comprises a set of displacement vectors (e.g., one for each voxel in the set of voxels). Each displacement vector may generally indicate the modifications to be applied to a corresponding voxel to transfer the desired style to the volume (e.g., a direction and distance to move the voxel).

At block 415, the neural transfer system determines a set of masking criteria to be used to mask the style transfer. In some embodiments, as discussed above, the masking criteria may be at least partially defined or provided by a user (e.g., a designer or three-dimensional modeler) to indicate the desired style of the output. For example, as discussed above, the masking criteria may include position-based masking (e.g., adjusting the style transfer for each voxel based on its position relative to the volume itself, relative to the environment, and/or relative to the motion of the volume and/or voxel relative to the space), age-based masking (e.g., adjusting the style transfer of each voxel based on how many frames have elapsed, in the animation, since the voxel was created), and the like.

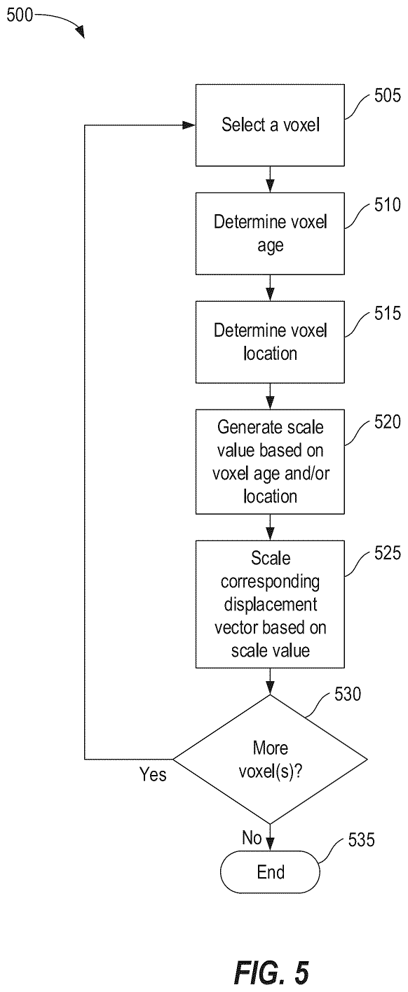

At block 420, the neural transfer system masks the vector field based (at least in part) on the determined masking criteria to generate a masked vector field (e.g., the masked vector field 130 of FIG. 1). In some embodiments, masking the vector field includes scaling each displacement vector in the vector field by a determined scaling factor determined based on the masking criteria, as applied to the voxel to which the displacement vector corresponds. For example, the neural transfer system may determine the age of a given voxel (e.g., where the age itself was determined or defined during a simulation phase of creating the volume), the positioning of a given voxel, and the like to determine a style scale. The neural transfer system may then scale the corresponding displacement vector for the given voxel using this determined scale (e.g., to reduce to eliminate style transfer for voxels on the leading edge of the volume's motion, for voxels in designated non-transfer regions, for newly created voxels, and the like). One example method for masking the vector field is discussed in more detail below with reference to FIG. 5.

At block 425, the neural transfer system modifies the set of voxels (accessed at block 405) based on the masked vector field to generate a set of modified voxels (e.g., the modified voxels 140 of FIG. 1). For example, as discussed above, the neural transfer system may apply the masked vector field by, for each given voxel in the set of voxels, displacing (or otherwise transforming or modifying) the given voxel based on the corresponding (masked) displacement vector in the masked vector field. That is, the neural transfer system may move the voxel along the corresponding masked (e.g., scaled) displacement vector in the three-dimensional virtual space.

At block 430, the neural transfer system determines whether there is at least one additional frame remaining in the animation. If so, the method 400 returns to block 405 to access the set of voxels for the next frame. If not, the method 400 continues to block 435. Although the illustrated example depicts processing each frame (e.g., each set of voxels) independently, in some aspects, the neural transfer system may perform some or all of depicted operations on some or all of the frames jointly and/or in parallel. For example, the VNST model may process a sequence of several frames (e.g., several sets of voxels) to generate one or more vector fields. For example, in some embodiments, the VNST model may process multiple frames (e.g., multiple sets of voxels) at a time to improve temporal coherence of the style transfer.

At block 435, the neural transfer system outputs the modified voxels. In some aspects, outputting the modified voxels may include displaying the modified voxels on a display (e.g., of a designer). In some aspects, outputting the modified voxels may include providing the modified voxels to another system or entity for further processing. In some aspects, outputting the modified voxels may include rendering one or more images (e.g., one or more frames) depicting the modified voxels from one or more angles to enable visualization of the transferred style.

### Example Method for Masking Vector Fields to Improve Volumetric Neural Style Transfer on Voxel Data

FIG. 5 is a flow diagram depicting an example method 500 for masking vector fields to improve volumetric neural style transfer on voxel data, according to some embodiments of the present disclosure. In some aspects, the method 400 is performed by a neural transfer system, such as the neural transfer system 105 of FIG. 1 and/or the neural transfer systems discussed above with reference to FIGS. 2-4. In some aspects, the method 500 provides additional detail for block 420 of FIG. 4.

At block 505, the neural transfer system selects a voxel from the set of voxels (e.g., the input voxels 110 of FIG. 1, which may have been generated using a physics simulator). Generally, the neural transfer system can use any suitable technique to select the voxel (including randomly or pseudo-randomly), as the neural transfer system will process each voxel during the method 500.

At block 510, the neural transfer system determines the age of the selected voxel. For example, as discussed above, the voxel age may refer to the number of frames and/or the time that has elapsed, in an animation (e.g., a sequence of frames) since the voxel was created. In some aspects, the age of the voxel may additionally or alternatively refer to the number of frames remaining in the animation until the voxel is deleted or removed, until the animation ends, and the like.

At block 515, the neural transfer system determines the location (e.g., position) of the selected voxel. For example, as discussed above, the voxel location may refer to the position of the voxel relative to the volume or another object (e.g., whether the selected voxel is in a designated non-transfer area, whether the voxel is on the surface or interior of the volume, whether the voxel is on the top, side, or bottom of the volume, and the like), the position of the voxel relative to the world, the position of the voxel relative to motion of the volume (e.g., whether the voxel is on the leading or trailing surface of the volume), and the like.

At block 520, the neural transfer system generates a scale value (also referred to as a scaling value and/or scaling factor, as discussed above) for the style transfer to the selected voxel based on the voxel's age and/or location. For example, as discussed above, the neural transfer system may use a set of rules such as setting the scale to be directly proportional to the age of the voxel (e.g., where older voxels have higher scaling factors), directly proportional to the distance between the voxel and the leading edge of motion (e.g., where voxels nearer to the leading surface have lower scaling factors), directly proportional to the distance between the voxel and designated non-transfer areas in the space (e.g., where voxels nearer to the designated areas have lower scaling factors), and the like. In some aspects, this dynamic scaling may include caps or limits on the scaling, such as a defined minimum scale, a defined maximum scale (e.g., regions where the scaling or style is pushed beyond the original bounds indicated by the vector field), and the like. In some embodiments, the rules may defined scaling gradients (e.g., indicating that the scaling factor should be unchanged for voxels further than a defined distance from the leading edge, and reduced uniformly or non-uniformly to a defined minimum at the leading surface).

Generally, as discussed above, the neural transfer system may use a wide variety of rules and characteristics of the voxels to set the scaling factor. For example, in some aspects, areas may be designated as enhanced style transfer regions, or the neural transfer system may determine to set style transfer inversely proportional to the proximity of the voxel to the leading surface of the volume and/or inversely proportional to the age of the voxel.

At block 525, the neural transfer system scales the displacement vector (from the vector field) that corresponds to the selected voxel based on the generated scale value. For example, as discussed above, the neural transfer system may multiply the vector by the scalar scale. That is, in some aspects, the neural transfer system may adjust the length of the vector (e.g., reducing or increasing the distance that the voxel will be displaced, without changing the direction of the displacement). In some aspects, the neural transfer system may additionally or alternatively modify the directionality of the displacement (e.g., changing the direction of the vector). For example, modifying the directionality of the displacement may be performed when blending between two independent style vectors, each with their own coherent displacement vectors.

At block 530, the neural transfer system determines whether there is at least one voxel remaining to be processed. If so, the method 500 returns to block 505. If not, the method 500 terminates at block 535. Although the illustrated example depicts a sequential process for conceptual clarity (e.g., where the neural transfer system iteratively selects and processes each voxel independently), in some embodiments, the neural transfer system may select and process some or all of the voxels in parallel.

### Example Method for Volumetric Neural Style Transfer

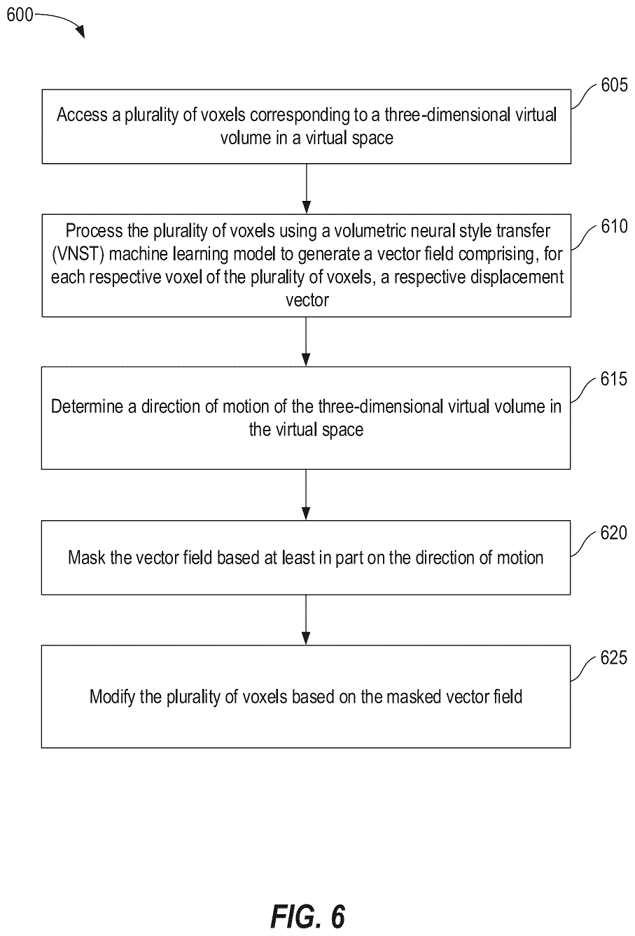

FIG. 6 is a flow diagram depicting an example method 600 for volumetric neural style transfer, according to some embodiments of the present disclosure. In some aspects, the method 600 is performed by a neural transfer system, such as the neural transfer system 105 of FIG. 1 and/or the neural transfer systems discussed above with reference to FIGS. 2-5.

At block 605, a plurality of voxels (e.g., the voxels 110 of FIG. 1) corresponding to a three-dimensional virtual volume in a virtual space is accessed.

At block 610, the plurality of voxels is processed using a volumetric neural style transfer (VNST) machine learning model (e.g., the VNST component 115 of FIG. 1) to generate a vector field (e.g., the vector field 120 of FIG. 1) comprising, for each respective voxel of the plurality of voxels, a respective displacement vector.

At block 615, a direction of motion of the three-dimensional virtual volume in the virtual space is determined.

At block 620, the vector field is masked based at least in part on the direction of motion.

At block 625, the plurality of voxels is modified (e.g., to create the modified voxels 140 of FIG. 1) based on the masked vector field (e.g., the masked vector field 130 of FIG. 1).

### Example Computing Device for Volumetric Neural Style Transfer

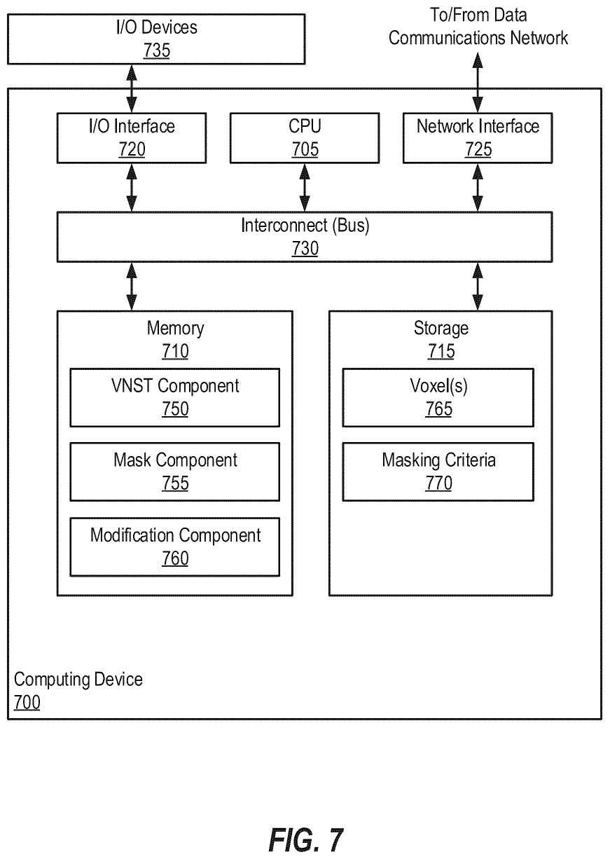

FIG. 7 depicts an example computing device 700 configured to perform various aspects of the present disclosure. In some embodiments, the computing device 700 corresponds to a neural transfer system, such as the neural transfer system 105 of FIG. 1 and/or the neural transfer systems discussed above with reference to FIGS. 2-6.

Although depicted as a physical device, in embodiments, the computing device 700 may be implemented as a virtual device or service, or across a number of devices (e.g., in a cloud environment). As illustrated, the computing device 700 includes a processor 705, memory 710, storage 715, I/O interface 720, and a network interface 725. In the illustrated embodiment, the processor 705 retrieves and executes programming instructions stored in memory 710, as well as stores and retrieves application data residing in storage 715. The processor 705 is generally representative of a single CPU, a GPU, a CPU and a GPU, multiple CPUs, multiple GPUs, a single CPU or GPU having multiple processing cores, and the like. The memory 710 is generally included to be representative of a random access memory. Storage 715 may be any combination of memory or storage components, including (but not limited to) disk drives, flash-based storage devices, and the like, and may include fixed storage devices, removable storage devices or a combination both, such as fixed disk drives, removable memory cards, caches, optical storage, network attached storage (NAS), or storage area networks (SAN).

In some embodiments, I/O devices 735 (such as a mouse, a keyboard, a monitor, a touchscreen, a GUI, etc.) are connected via the I/O Interface(s) 720. Further, via the network interface 725, the computing device 700 can be communicatively coupled with one or more other devices and components (directly or indirectly), such as content servers, via one or more networks.

As illustrated, the memory 710 includes a VNST component 750, a mask component 755, and a modification component 760. Although depicted as software residing in memory, in embodiments, the functionality of the depicted components (and others not depicted) may be implemented using hardware, software, or a combination of hardware and software. In some embodiments, the memory 710 may be used to temporarily store the depicted components while the processor 705 executes the instructions of each during runtime. In some aspects, the components may otherwise reside in another location, such as in storage 715.

The depicted components are generally configured to perform one or more embodiments disclosed herein. For example, in one embodiment, the VNST component 750 (which may correspond to the VNST component 115 of FIG. 1) is used to process input voxels using one or more trained VNST machine learning models, as discussed above. For example, the VNST component 750 may process the voxels 765 to generate vector fields (e.g., the vector field 120 of FIG. 1) indicating how the voxel(s) should be modified to transfer a style (learned during training of the VNST component 750) to the volume.

The mask component 755 (which may correspond to the mask component 125 of FIG. 1) may be used to mask the vector field in order to control the style transfer to the volume, as discussed above. For example, as discussed above, the mask component 755 may scale the displacement vectors (or other vectors) of the vector field based on voxel characteristics such as the voxels' ages, the voxels' positions, and the like.

The modification component 760 (which may correspond to the modification component 135 of FIG. 1) may be used to apply masked vector fields to modify the voxels in order to generate modified voxels (e.g., the set of modified voxels 140 of FIG. 1), as discussed above. For example, as discussed above, the neural transfer system may displace each voxel along the corresponding masked displacement vector to impart the desired style into the volume.

In the illustrated embodiment, the storage 715 includes a set of voxels 765 and masking criteria 770. Though depicted as residing in storage 715 for conceptual clarity, in embodiments, the voxels 765 and the masking criteria 770 may reside in any suitable location. The voxels 765 may generally correspond to three-dimensional regions or portions of a volumetric entity (e.g., the voxels 110 of FIG. 1) in a three-dimensional virtual space.

The masking criteria 770 may generally correspond to any rules and/or characteristics used to mask or scale the style transfer, along with how such rules are to be applied (e.g., the amount of scaling, how scaling is determined for a given voxel, and the like).

### Additional Considerations

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
accessing a plurality of voxels corresponding to a three-dimensional virtual volume in a virtual space;
processing the plurality of voxels using a volumetric neural style transfer (VNST) machine learning model to generate a vector field comprising, for each respective voxel of the plurality of voxels, a respective displacement vector;
determining a direction of motion of the three-dimensional virtual volume in the virtual space;
masking the vector field based at least in part on the direction of motion; and
modifying the plurality of voxels based on the masked vector field.

2. The method of claim 1, further comprising:
rendering an image of the modified plurality of voxels; and
outputting the image via a display.

3. The method of claim 1, wherein:
masking the vector field comprises scaling displacement vectors of the vector field based at least in part on the determined direction of motion, and
displacement vectors corresponding to a first set of voxels, of the plurality of voxels, on a trailing surface of the three-dimensional virtual volume relative to the direction of motion are scaled by larger amounts, as compared to displacement vectors corresponding to a second set of voxels, of the plurality of voxels, on a leading surface of the three-dimensional virtual volume relative to the direction of motion.

4. The method of claim 3, wherein masking the vector field comprises scaling the displacement vectors corresponding to the second set of voxels to a value of zero.

5. The method of claim 1, further comprising:
identifying a set of voxels, of the plurality of voxels, designated as non-transfer; and
masking the vector field based further on the set of voxels.

6. The method of claim 5, wherein masking the vector field based on the set of voxels comprises scaling displacement vectors corresponding to the set of voxels to a value of zero.

7. The method of claim 1, further comprising:
determining respective ages of each respective voxel of the plurality of voxels; and
masking the vector field based further on the respective ages of the plurality of voxels.

8. The method of claim 7, wherein masking the vector field based further on the respective ages of the plurality of voxels comprises, for each respective voxel of the plurality of voxels, scaling a respective displacement vector of the vector field by an amount directly proportional to the respective age of the respective voxel.

9. The method of claim 1, wherein modifying the plurality of voxels based on the masked vector field comprises displacing at least one voxel of the plurality of voxels along a corresponding displacement vector, from the masked vector field, in the virtual space.

10. One or more non-transitory computer readable media containing, in any combination, computer program code that, when executed by operation of a computing system, performs operations comprising:
accessing a plurality of voxels corresponding to a three-dimensional virtual volume in a virtual space;
processing the plurality of voxels using a volumetric neural style transfer (VNST) machine learning model to generate a vector field comprising, for each respective voxel of the plurality of voxels, a respective displacement vector;
determining a direction of motion of the three-dimensional virtual volume in the virtual space;
masking the vector field based at least in part on the direction of motion; and
modifying the plurality of voxels based on the masked vector field.

11. The one or more non-transitory computer-readable media of claim 10, wherein:
masking the vector field comprises scaling displacement vectors of the vector field based at least in part on the determined direction of motion, and
displacement vectors corresponding to a first set of voxels, of the plurality of voxels, on a trailing surface of the three-dimensional virtual volume relative to the direction of motion are scaled by larger amounts, as compared to displacement vectors corresponding to a second set of voxels, of the plurality of voxels, on a leading surface of the three-dimensional virtual volume relative to the direction of motion.

12. The one or more non-transitory computer-readable media of claim 11, wherein masking the vector field comprises scaling the displacement vectors corresponding to the second set of voxels to a value of zero.

13. The one or more non-transitory computer-readable media of claim 10, the operations further comprising:
identifying a set of voxels, of the plurality of voxels, designated as non-transfer; and
masking the vector field based further on the set of voxels.

14. The one or more non-transitory computer-readable media of claim 10, the operations further comprising:
determining respective ages of each respective voxel of the plurality of voxels; and
masking the vector field based further on the respective ages of the plurality of voxels.

15. The one or more non-transitory computer-readable media of claim 10, wherein modifying the plurality of voxels based on the masked vector field comprises displacing at least one voxel of the plurality of voxels along a corresponding displacement vector, from the masked vector field, in the virtual space.

16. A system, comprising:
one or more processors;
one or more memories storing a program, which, when executed on any combination of the one or more processors, performs operations, the operations comprising:
accessing a plurality of voxels corresponding to a three-dimensional virtual volume in a virtual space;
processing the plurality of voxels using a volumetric neural style transfer (VNST) machine learning model to generate a vector field comprising, for each respective voxel of the plurality of voxels, a respective displacement vector;
determining a direction of motion of the three-dimensional virtual volume in the virtual space;
masking the vector field based at least in part on the direction of motion; and
modifying the plurality of voxels based on the masked vector field.

17. The system of claim 16, wherein:
masking the vector field comprises scaling displacement vectors of the vector field based at least in part on the determined direction of motion, and
displacement vectors corresponding to a first set of voxels, of the plurality of voxels, on a trailing surface of the three-dimensional virtual volume relative to the direction of motion are scaled by larger amounts, as compared to displacement vectors corresponding to a second set of voxels, of the plurality of voxels, on a leading surface of the three-dimensional virtual volume relative to the direction of motion.

18. The system of claim 16, the operations further comprising:
identifying a set of voxels, of the plurality of voxels, designated as non-transfer; and
masking the vector field based further on the set of voxels.

19. The system of claim 16, the operations further comprising:
determining respective ages of each respective voxel of the plurality of voxels; and
masking the vector field based further on the respective ages of the plurality of voxels.

20. The system of claim 16, wherein modifying the plurality of voxels based on the masked vector field comprises displacing at least one voxel of the plurality of voxels along a corresponding displacement vector, from the masked vector field, in the virtual space.
